(19) United States
(12) Patent Application Publication
(10) Pub. No.: US 2002/0032632 A1
(43) Pub. Date: Mar. 14, 2002

(54) Online commodities trading system with anonymous counter bid/offer function

(76) Inventor: Pierre Sernet, New York, NY (US)

Correspondence Address: Leighton K. Chong, Ostrager Chong & Flaherty (Hawaii), Suite 1200, 841 Bishop Street, Honolulu, HI, 96813, US

(21) Appl. No.: 09/731,542

(22) Filed: Dec. 6, 2000

Related U.S. Application Data
(60) Provisional application No. 60/169,538, filed on Dec. 7, 1999.

(51) Int. Cl. G06F 17/60

(52) U.S. Cl. 705/37

(57) ABSTRACT

An online trading system includes: a Bid/Offer input interface for allowing users to enter the terms of bids or offers for posting in the system anonymously without identification of the submitter; a Trading Summary interface operable by users for displaying an anonymous postings of bids and offers and for identifying a match of a bid and a counterpart offer; a Bid/Offer database for storing and retrieving data records of bids and offers submitted to the system; and a Counter Bid/Offer interface for allowing a user to retrieve the data record for a selected bid or offer and change or modify one or more terms thereof and submit the countered or modified bid or offer as a new posting in the system without identification of the submitter. The system allows users to remain anonymous while engaging in fine-tuned “negotiation” on terms through the countering procedure. The system is especially useful for trading in commodities contracts which have a large number of predetermined terms for a contract. When a transaction is closed, the system automatically notifies the parties and generates a final contract for them.

This U.S. patent application claims the priority of U.S. Provisional Application 60/169,538 filed on Dec. 7, 1999, entitled “Network-Based Trading System With Anonymous Bid/Offer Matching”, by the same inventor.

### FIELD OF THE INVENTION

This invention relates to a system for conducting online trading systems and electronic marketplaces for commodities and, in particular, to such systems where a trader-user can remain anonymous while conducting bid, offer and trading-related activities with a high degree of precision and efficiency.

### BACKGROUND OF THE INVENTION

Online trading systems allow for more efficient marketplace interactions when participants can remain anonymous while conducting their trading activities. If the identities of the trading parties were known, then that information may adversely affect the fluidity of the marketplace since knowledge of who is making what bids and offers may induce a trader to engage in strategic behaviors against specific traders and alter the bids or offers they would otherwise make against an open market of participants. However, maintaining anonymity in online trading systems is problematic when a trader making a bid is a close match to a counterpart making a close offer. If only one or a few detailed terms separate the parties from agreeing on a contract, then direct interaction with the other trader on fine-grained modifications of remaining terms can often facilitate bridging the gap and making the deal. This is particularly important in commodities trading where there may be many terms of different levels of importance affecting the acceptability of a deal between parties. Therefore, one of the main technical problems in online trading systems has been how to permit fine-grained interactions between traders while still maintaining anonymity.

An example of one proposal to solve this problem is explained in U.S. Pat. No. 5,924,082 to Silverman, issued on Jul. 13, 1999. The Silverman Patent is directed to a network system connected to remote terminals for negotiated matching of potential parties to a transaction. Each user enters ranking data indicating their preferences for executing transactions online, and trading data indicating the primary or “firm” terms of transactions they are willing to execute. The system may filter listed bid/offer transactions to be matched based upon the ranking data the user has indicated for acceptability of transactions. A matching computer which operates the system compares the trading data entered by users and uses the ranking data from each user to identify when the primary or “firm” terms of transactions are matched between parties. The system then enables messages to be transmitted between the parties to negotiate secondary or “soft” terms for a transaction. The communications may be in a structured form via a display box displayed on each party's screens into which each party can modify the displayed soft parameters until all terms are acceptable to the parties, or it may be free-style text dialog that is typed in by the parties in a “Conversations” box that also appears in the other user's display. When agreement has been reached on all firm and soft parameters of a transaction, the matching computer executes the transaction and removes it from the system.

A disadvantage of the above type of firm/soft matching system is that once certain parties have been identified as matching in primary terms, the negotiations on soft terms is conducted only between the counterpart parties, while other traders are not provided with information on the ongoing negotiations to allow them to participate in making counter offers. This has the effect of excluding the rest of the marketplace from participation once the system has identified a tentative match on primary terms. However, in actual marketplace environments, there may be other traders whose offers did not match the primary terms of a bid, yet who might be more willing to meet the bidder's soft terms than the the counterpart who did match the primary terms of the bid, and vice versa.

### SUMMARY OF THE INVENTION

Accordingly, it is a principal object of the present invention to provide an online trading system for commodities which permits fine-grained interactions between traders while still maintaining anonymity. It is a particular object that the system provide a facility in which traders can readily ascertain close matches with other parties in order to fine-tune the terms of their bids or offers, while not being excluded from interactions on a deal until one party has completely met all terms of acceptance with a counterpart party.

In accordance with the present invention, an online trading system comprises:

(a) a Bid/Offer input interface for allowing a user to enter terms in a predetermined set of fields for a bid or offer and to submit the bid or offer for posting in the system anonymously without identification of the submitter;

(b) a Trading Summary interface operable by users for displaying an anonymous postings of bids and offers submitted to the system, and for identifying a match of a bid and a counterpart offer with respect to the terms in the predetermined set of fields of each counterpart;

(c) a Bid/Offer database for storing and retrieving data records of bids and offers submitted to the system; and

(d) a Counter Bid/Offer interface operable by a user to select a pending bid or offer displayed on a display of the Trading Summary interface, to retrieve the corresponding data record from the Bid/Offer database and display the terms existing in the predetermined set of fields without identification of the submitter and then to counter or modify one or more terms and submit the countered or modified bid or offer as a new posting in the system without identification of the submitter,

whereby users of the system can remain anonymous while engaging in countering or modifying an original bid or offer as a new posting in the system in order to move progressively toward a match of terms in the predetermined set of fields.

In a preferred embodiment of the online trading system, the Bid/Offer input interface allows entry for a large number of terms typical of commodities contracts, such as stock type, quantity, price, shipping terms, delivery date, delivery location, payment terms, etc. The system allows preferences to be set for each user as to counterparties they are precluded or have precluded from dealing with. The Trading Summary interface includes a function to filter or to find best offers that are closest matches to a selected bid, and vice versa. Users can continue to submit bids, offers, and counters until a complete match of terms in the predetermined set of fields exists, then the system removes the matching transactions from the Trading Summary interface, and generates a notification to the parties and a final contract for the closed transaction. The Bid/Offer input interface can include an additional field for entry of “administrative” terms for inclusion in a final contract between the parties but which are not taken into account in determining a match.

Other objects, features, and advantages of the present invention will be described in further detail below, with reference to the following drawings:

### BRIEF DESCRIPTION OF DRAWINGS

FIG. 1 is a schematic diagram of the overall process architecture for an example of an online trading system for commodities (sugar) contracts in accordance with the invention.

FIG. 2 is a schematic diagram of the overall process architecture for the user interface in the example of the online trading system of FIG. 1.

FIG. 3 is a schematic diagram of the screen displays comprising the user interface in the example of the online trading system of FIG. 1.

FIG. 4 is a schematic diagram of the overall system architecture in the example of the online trading system of FIG. 1.

FIG. 5 is a block diagram of the functions or screen displays accessible through the user interface in the example of the online trading system of FIG. 1.

FIG. 6 is an example of a screen display for providing message alerts to users of the system.

FIG. 7 is an example of a Trading Summary Screen used for trading activities by users of the system.

FIGS. 8A and 8B are an example of a screen display of an input form for submitting a New Bid or New Offer in the system.

FIG. 9 is an example of a screen display of a form for submitting a counter to a Bid or Offer in the system.

FIG. 10 is an example of use of a Find Best Bids function to restrict a screen display to only Bids or Offers of interest to the trader.

### DETAILED DESCRIPTION OF INVENTION

In the following detailed description, a preferred embodiment of the online trading system of the present invention is described using the example of a commodities trading system for sugar contracts. However, it is to be understood that the guiding principles of the invention are not limited to this example. The system may be used for purposes of this invention for many other types of commodities trading systems, and, more broadly, to any type of online trading system where anonymous fine-grained interactions on terms between parties is required.

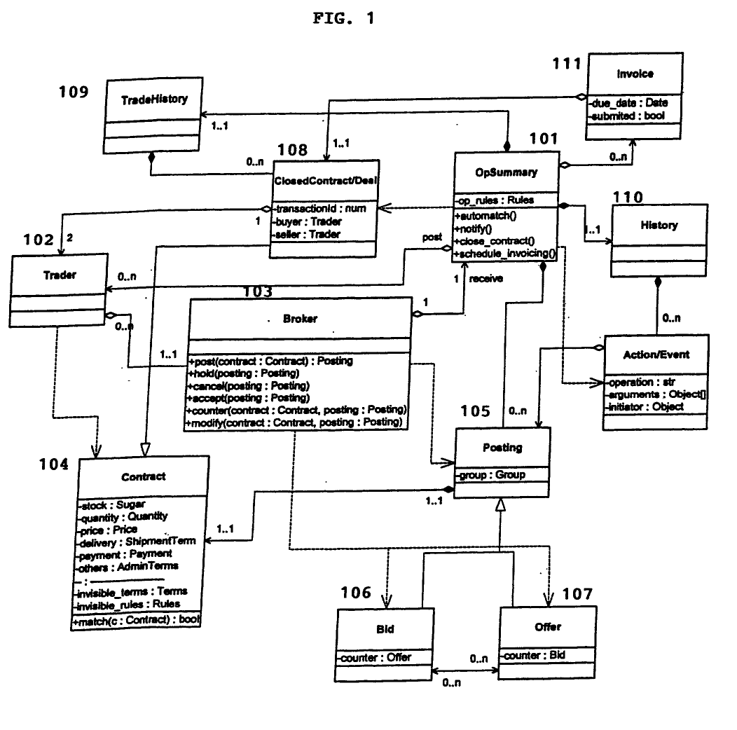

Referring to FIG. 1, the overall process architecture for the example of an online trading system for sugar contracts is illustrated. This diagram provides a representation of the process requirements for the trading domain. The commodity being traded in this case is white and raw sugar. The main trading unit is a SugarContract. The SugarContract typically encompasses a predetermined set of terms, such as Type of Sugar (white/raw, quality), SugarOrigin, Packing, Maturity, Quantity, Price, Payment, ShipmentTerms (CAF/FOB/FOT, Origin and/or Destination, Loading/Unloading Terms, Penalty), and Administrative or Secondary Terms.

The online commodity trading system handles transactions in terms of traders, brokers, bids, offers, etc., and defines the relationships among them. Traders 102 can place bids/offers, accept deals, etc., through Brokers 103. The Broker uses a data class named Operational Summary 101 (OpSummary) to store, track, and dispose of active postings. Operational Summary is not only a passive storage, but it also contains all the operational rules of how the market operates and applies them to all new postings and user requests. The Operational Summary 101 is also responsible for providing the trading information to be made visible to the Traders and Broker who are approved as authorized Users 201a of the system. The main trading unit is a Contract 104 which is attached to (associated with) a Posting 105. The Posting can be a Bid 106 or an Offer 107. Every accepted contract is converted to a ClosedContract 108 which is identified by a transaction number, a buyer Trader, and a seller Trader. All the Closed Contracts are kept in a TradeHistory (data) object 109. There are also objects describing system History 110 and Invoices 111.

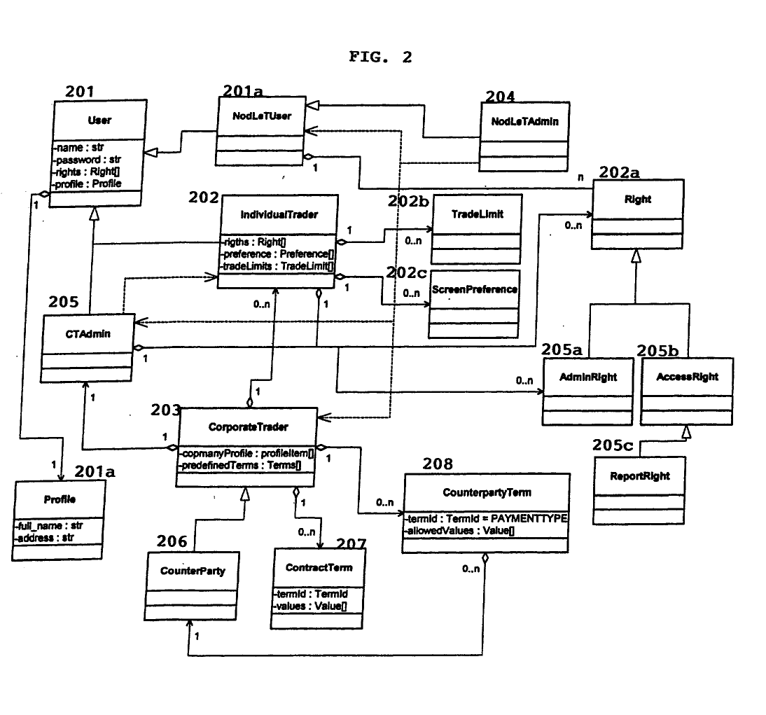

Referring to FIG. 2, the overall process architecture for the user interface in the online trading system is illustrated. Users 201 are registered by specifying name, password, rights of access in the system, and profile, which is stored in a Profile object 201a. Users may be Individual Traders 202 or Corporate Traders 203. An Individual Trader will set their rights of access 202a, trade limits 202b, and screen preferences 202c by submission for approval by the System Adminstrator 204 during registration as a User. A Corporate Trader 203 has access rights, profile, and terms established through a Corporate Trader (CT) Administrator 205, which sets the rights of access 202a, trade limits 202b, and screen preferences 202c for all Corporate Traders who are identified with that Corporate group. The CT Administrator also sets the Administrator's Rights 205a, Access Rights 205b, and Report Rights 205c. The Corporate Trader 203 can also set their requirements for CounterParties 206 they will transact with, Contract Terms 207 which they are authorized offer, and CounterParty Terms 208 to which they will accept being bound.

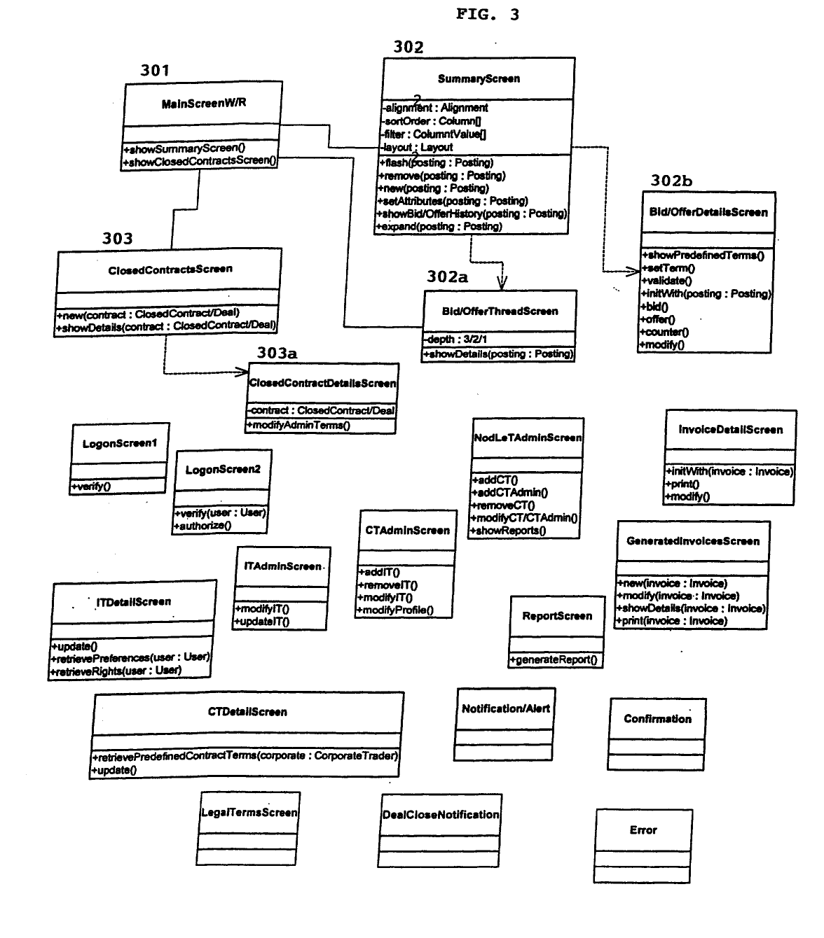

Referring to FIG. 3, the User Interface domain to the system is illustrated. The Main Screen is the “home page” displayed after a User has logged on and been recognized as an authorized user. The Main Screen has as comonents the Trading Summary Screen 302 and the ClosedContracts Screen 303. The Trading Summary Screen 302 displays all of the pending bids and offers being handled by the system, and may be adjusted for alignment, sort order (order of display of entries), filtering (display of entries of selected type/value), layout, adding or removing postings, setting the attributes of a posting, showing the Bid/Offer History of a posting, and expanding to display the complete record of a Bid/Offer posting. The Trading Summary Screen can be used to call up a detailed view of the Bid/Offer Thread Screen 302a and the Bid/Offer Details Screen 302b. Other displays handled by the system, which are outside the Users domain, include logon screens, System Adminstrator screens, Individual Trader (IT) screens, CT Admnistrator's screens, and report, invoicing, and notification screens.

System access is obtained by the process of user log-in and authentication. After the user completes the log-in process and is authenticated, the system will load user preferences (as stored for that user) and display the Main Screen. The Main Screen can invoke system functionality including several different historical and current displays. The System Administrator are “super users” meaning that they have unrestricted access all system functionality and settings. CT Administrators have access to several functions that enable them to maintain their corporate accounts within the system. CT Users have access to the functionality in the system defined by the CT Adminstrators. IT Users have access to the functionality that allows them to operate in a trading capacity within the system. As with the CT users, indication of a particular functionality does not mean that all IT users will have unrestricted use of that functionality.

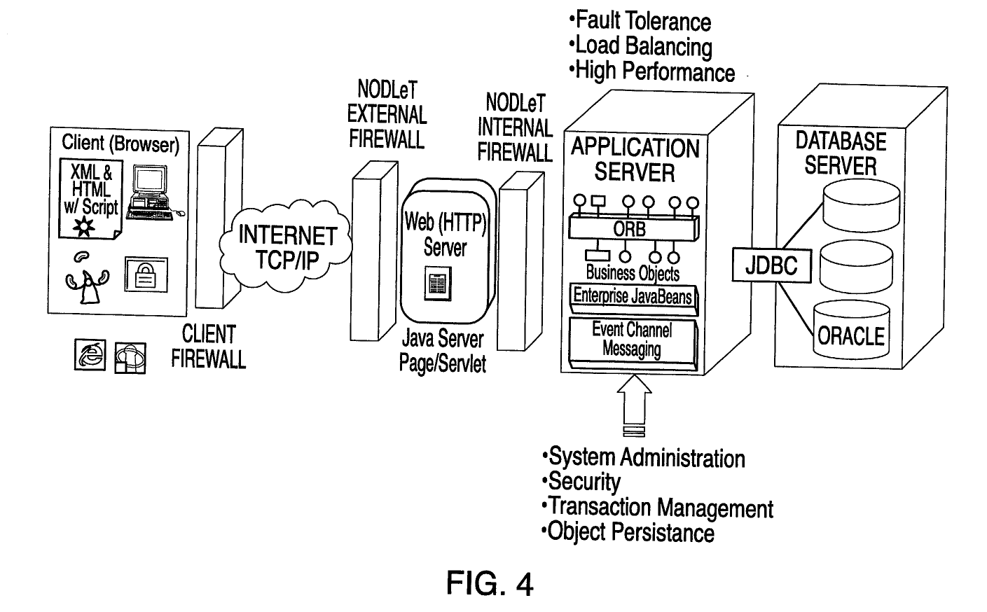

Referring to FIG. 4, the preferred technical architecture of the exemplary system is illustrated. Users connect to the system via their client (browser) computer access device which typically navigates through online pages via XML or HTML scripts. The client devices establish connection over the Internet using the standard TCP/IP protocol to the system server. The system server typically has an overall Web server configuration which includes a Java Server for handling Java applets or servelets, and is protected preferably by both an external firewall and an internal firewall. Behind the internal firewall, the main application server for the system handles all of the substantive functionality for the system, including system administration, security, transaction management, and datbase (object) management. The application server is coupled to a database server which provides high-capacity storage for the requirements of the system.

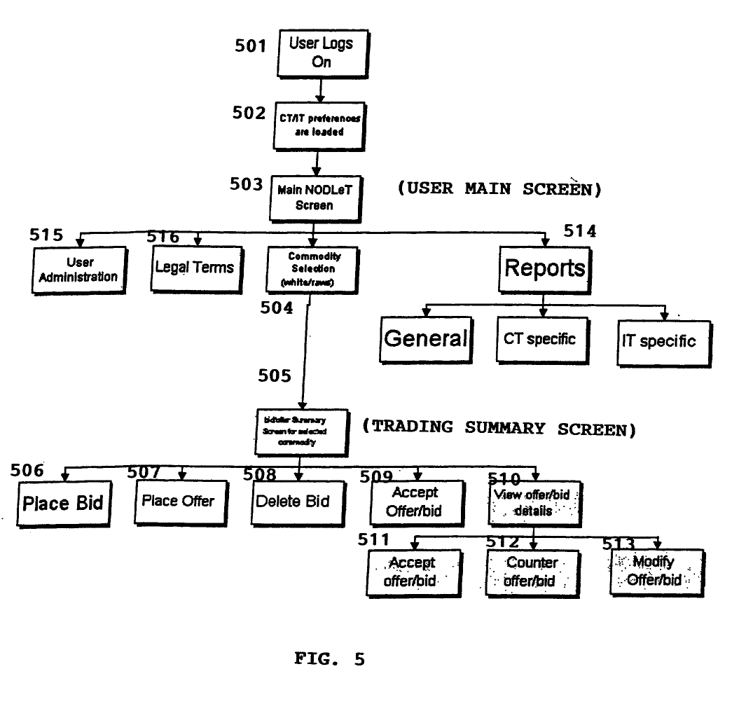

Referring to FIG. 5, the basic process flow for a typical user is illustrated. The user has previously registered as an authorized user of the system and has designated the user's preferences for trading activity and use of the functions of the system. These preferences are loaded upon the user's logging on in order to customize the functionality of the system to the user's preference profile. These preferences include deal matching criteria preferences as well as notification condition preferences. Changes to the profile can be made by submission to the system as an update. Following logon 501 and loading of preferences 502, the user is taken to the Main Screen at block 503. For trading activity, the user enters the commodity domain of the system from block 504 (here, white/raw sugar contracts) and views the Trading Summary Screen at block 505. Here the user can place bids at block 506 to posted offers, place offers at block 507, delete a bid at block 508, accept an offer or bid at block 509, or view offer/bid details at block 510. From the viewing of offer/bid details, the user can accept an offer/bid at block 511, counter an offer/bid at block 512, and/or modify an offer/bid at block 513. From the Main Screen, the user can also view Reports at block 514, handle (limited) user adminstration functions at block 516, or view legal terms at block 516, such as the system's terms of service or user privacy policies.

With regard to the bid and offer placement functions, the counter placement function is a special subset of the offer/bid function. The user can invoke the counter bid/offer function in order to fine-tune the “negotiation” on one or more terms of a closely matching offer or bid. As described further below, the user interface for the counter bid/offer function is designed to facilitate the user's viewing of the details of the many terms of the target offer or bid, and to adjust one or more terms for a counter that the user hopes will be acceptable to the counterparty. The counterparty can accept the counter bid/offer, or make its own counter offer/bid in a similar manner.

### Operation of User Interface Functions

In this example of a preferred embodiment of the invention, the Online Commodity Trading System is a real time online trading system that deals with the international trading of various commodities, such as sugar contracts. There are several classes of users within the NodLeT system. A Corporate Trader (CT) Administrator is a user that has only administrative rights. This user maintains the account information for the trading company that is a subscriber to the system. The CT Administrator has administrative rights to: (a) issue/manage passwords for corporate traders and individuals within the company; (b) authorize users to access the system remotely; (c) add or delete individuals under a Corporate Trader ID; (d) change corporate trader standard contract terms; (e) change company profile information sent to other traders by the system; and (f) set rules for trading with each counterpart and payment terms for each counterpart. Corporate Traders are traders within the system who are bound by the administrative settings selected by the CT Administrator. A Senior Individual Trader is a trader who has limited access to some administrative rights potentially including the ability to cancel postings by traders of the same corporation. Individual Traders are traders within the system who may trade commodities but have no administrative rights. A Business Analyst can only view activity on the system and may not trade or alter administrative rights.

The system can be accessed from any capable computer device having Internet connectivity and a standard browser. A listing of the typical computer hardware and software needed to run the online commodity trading application is provided in Appendix B hereto. A user accesses the online trading system on the Internet by entering the system's Internet address into the browser.

Connection to the system's Internet address brings the user to the system's LogOn screen. Each Corporate Trader (company trader) has an ID number, which is assigned by the system and distributed to the CT Administrator. Each user (Senior Individual Trader or Individual Trader) will have their own individual ID and password in addition to the Corporate ID to which they belong. To log onto the system's site, the user enters their Corporate ID, Individual ID and Password and clicks the Log On button. Upon log on, the user's previously set preferences are loaded with the system's server and are used to control the display of information on pages viewed by the user, including which transaction items are displayed for trading activities. The user is asked to review and accept the legal terms of use for the system. After accepting the legal terms, the user is brought to the Main Screen which is the gateway to all of the system's functionality.

The Main Screen (system's Home Page) has a navigation bar which provides the user with the following functions:

Log Off: Logs the user off the system.

Home: Brings the user back to the system's Home Page.

Preferences: Change user settings (Personal Info, Password, Contract Terms, Counterparts Rules).

Trading: Allows authorized users to perform functions related to the trading.

Reports: Allows authorized users to get reports on individual and system states.

Sitemap: Shows the sitemap with links to the different areas.

Besides the visual interface of screen displays, the system will also automatically notify the user of various events by sending the following types of messages which are posted on the Home Page or on the Trading Summary Screen:

An administrative notification.

An accepted posting or a closed deal.

When there is a close trading match in the system (all but one of the matching rules are met).

A posting has been deleted.

A warning to inform the user that a posting will be deleted.

Someone has countered one of the user's postings.

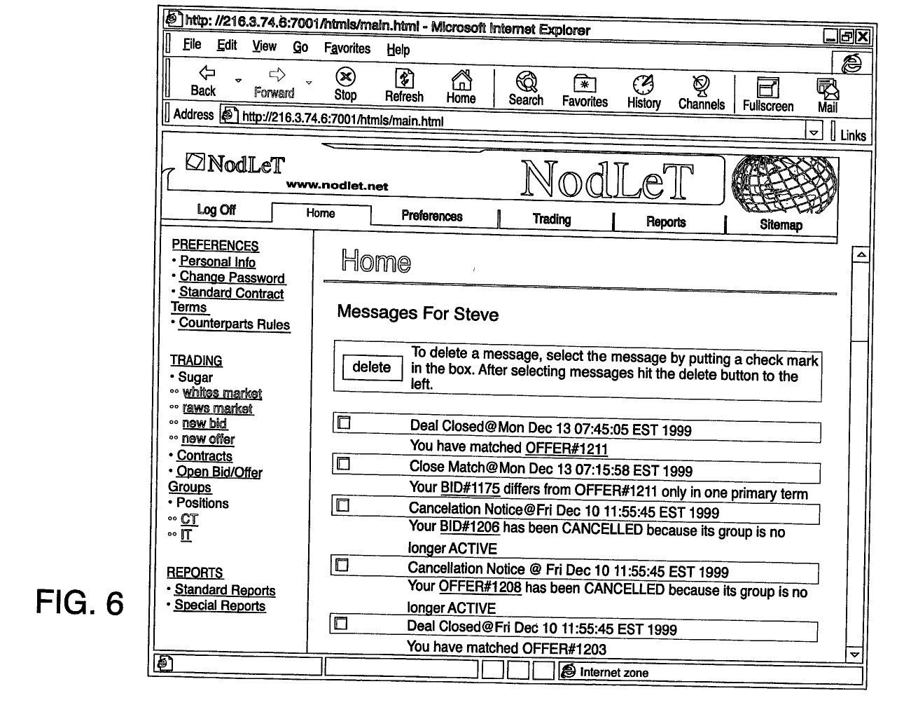

An example of a screen display of messages to a user is shown in FIG. 6. The following types of sample messages are illustrated: (indicated at 601) that an offer the user has posted differs from a bid by a counterpart in only one primary term; (602) that an offer posted by the user has been cancelled because the user's group has withdrawn from active trading; (603) that an offer posted by the user has been accepted; (604) that a bid placed by the user has matched an offer posted by a counterpart.

An important feature of the online trading system is the ability of the CT Adminstrator or Individual User to set counterpart rules. Counterpart rules allow a CT Administrator to specify which other system users the company will do business with and what payment term restrictions apply to that trading company (counterpart). Since the purpose of this type of system is to allow the parties posting and negotiating a bid/offer transaction to remain anonymous until a deal is closed, these settings prevent two counterparts from doing business with one another accidentally in their trading activities. For each company within the list of counterparts, the CT Administrator must specify whether the company will trade with that counterpart company and what kind of payment terms from that counterpart are acceptable.

Another important feature in the system is the set of matching rules which determine when two parties have reached agreement on all essential terms of a contract and the deal is to be closed. Since traders in any given commodity domain generally expect that the matching rules are uniform for all traders using the system, these rules are predetermined and established with the system and apply to all traders in that commodity domain. The system will close a deal and remove the counterpart bid and offer transactions from further trading activity when they match in all primary terms established in the matching rules of the system. The system will notify traders when a bid and offer are within one primary term to a match.

In the example of sugar contracts, the preferred system might have established matching rules corresponding to the primary terms of a sugar contract accepted in the industry, including, for example, Type of Sugar, Sugar Origin, Qunatity, Quality, NOR, Demurrage, Minimum/Maximum Polarization, Price, Term, Destination, Destination Port, Origin, Origin Port, Shipment Date, Package, Bag Type, Loading Terms, Unloading Terms, Payment Terms, etc. The user can view the matching rules maintained by the system on its Matching Rules Screen.

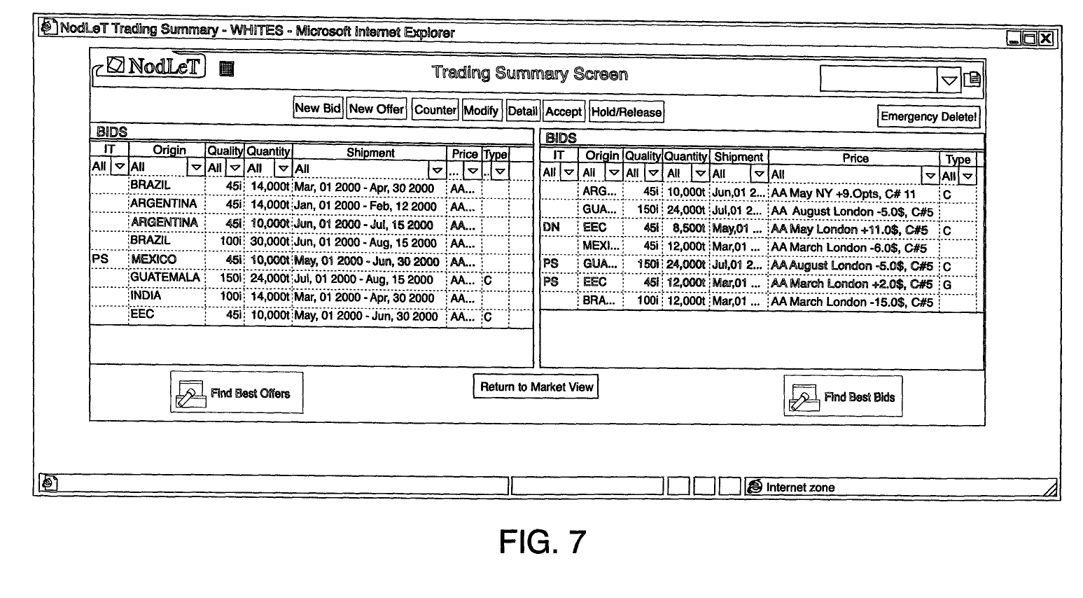

The user works from the Trading Summary Screen for all commodity trading activity. For the commodity domain of sugar contracts, two types of sugar contract subdomains are provided, white (refined) sugar and raw sugar. The user selects the subdomain type from a menu bar, and the Trading Summary Screen then lists all pending bids and offers in that domain, as illustrated in FIG. 7. The Trading Summary Screen is divided into two halves. The left side shows all the available Bids for WHITES (or RAWS depending on the type of sugar) while the right side displays all the Offers for WHITES (or RAWS as appropriate). For each type, the display shows information under the following column headings:

IT (Individual Trader): Initials in this IT column indicates that the posting was created by another trader within the same company. The user may not close a deal with this posting since trading with other members of the same company is not allowed. When an individual places a bid or offer, they will always see their own initials in the IT column.

Origin: The origin column indicates the sugar origin for a posting.

Quality: The quality column indicates the quality level (icumsa for whites, Max Pol for raws).

Quantity: The quantity column indicates the quantity in metric tons for a posting.

Shipment: The shipment column indicates the acceptable shipment dates for a posting.

Price: The price for a posting (against London or NY marketplace or fixed price per ton).

Type: The type column indicates special characteristics about this posting. If there is a “C” in the Type column, it indicates that this posting is a counteroffer to another posting in the system. If there is a “G” in the Type column, it indicates that this posting is part of a user's group and may be removed at any time in accordance with group rules.

The Trading Summary Screen has set of tabs for trading functions at an upper portion of the screen which provide the user with the following trading options:

New Bid: Allows authorized user put in a new Bid.

New Offer: Allows authorized user to put in a new Offer.

Counter: Allows authorized user to put in a counter Bid/Offer.

Modify: Allows authorized user to modify a posting.

Detail: Allows authorized user to review the details of a Bid/Offer.

Accept Allows authorized user to accept a Bid/Offer.

Hold/Release: Allows authorized user to hold or release a posting.

Emergency Delete: Allows authorized user to remove postings.

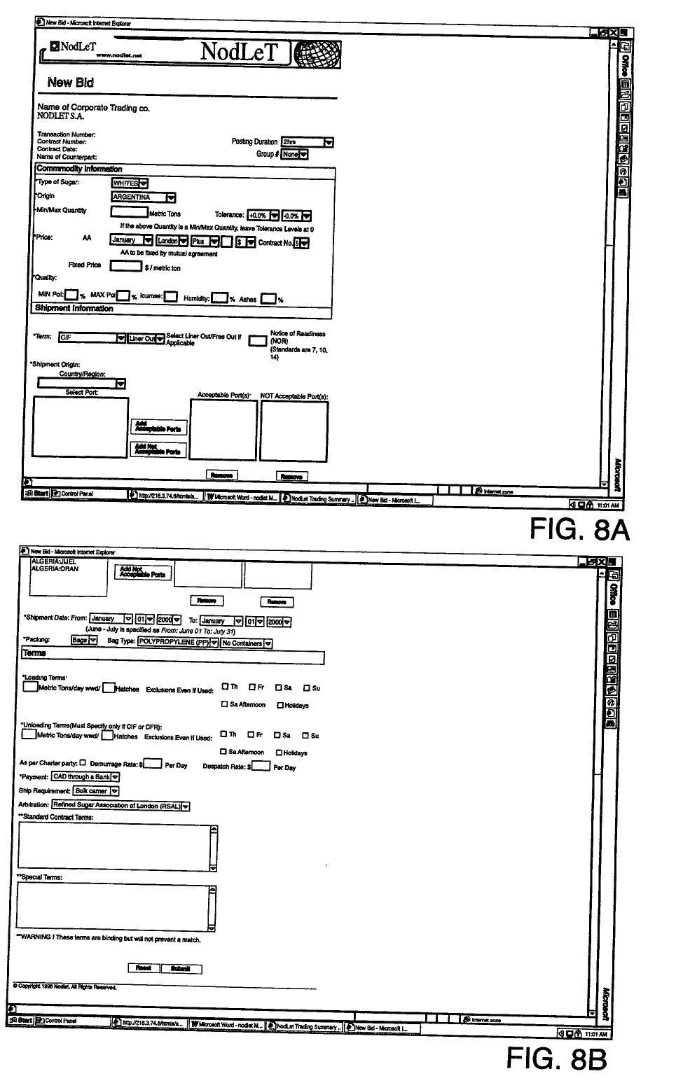

Selecting the New Bid or New Offer function brings up an input template form having input fields for all of the primary terms established in the system for closing a sugar contract. A sample of a New Bid form is shown in FIGS. 8A and 8B. Each field in the form is explained in more detail in Appendix A. Some of the input fields have pull down menus (down arrow buttons) to restrict or simplify selection of options available to the user. Near the end of the form are text input boxes for “Standard Contract Terms” and “Special Terms”. These are for term provisions that the submitting party wants to have in the final contract and are therefore binding, but are deemed to be administrative terms which will not be used in determining a match. At the bottom of the form are Reset and Submit buttons. The Reset button clears the form to allow the user to start from the beginning, and the Submit button takes the data and submits it for storage as a transaction data record in the system.

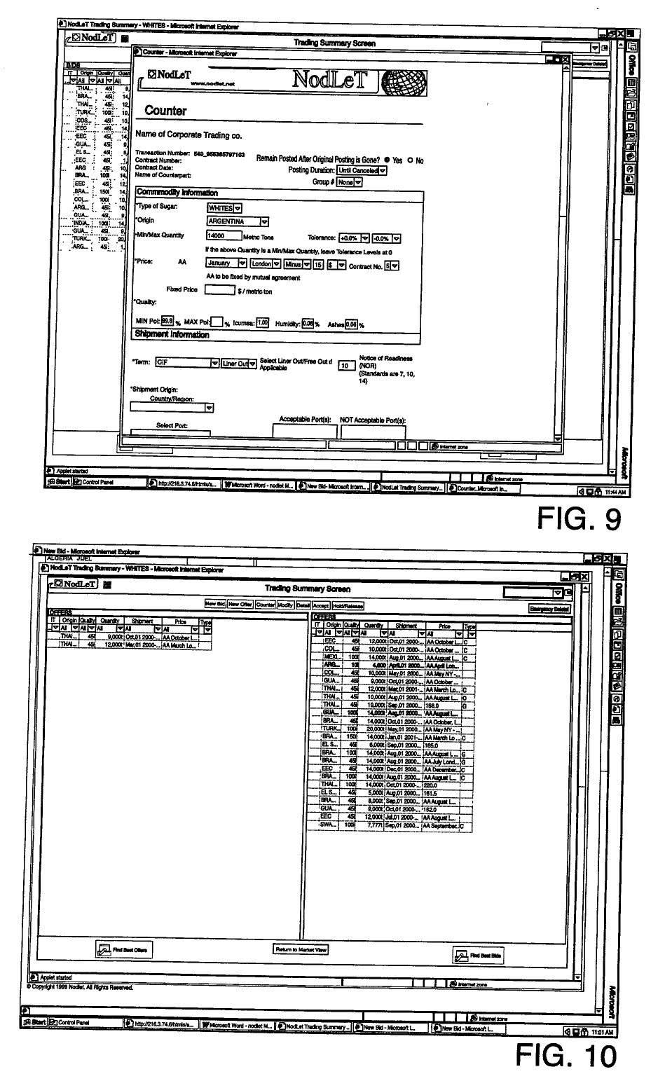

An authorized user may opt to place counterbids or counteroffers to the bid or offer of another party by selecting the bid or offer from the Trading Summary Screen and hitting the Counter button at the top of the screen. This will bring up a Counter form, as illustrated in FIG. 9, which is in the same format as the new bid or offer entry form. The fields of the Counter form are initially populated with the same data that exist in the bid or offer record to which the counter is being made. The user may modify any of these fields to adjust the terms of the user's counterbid or counteroffer. The user may also edit or add to the administrative terms in the text input boxes in the manner they would like to see included in the final contract. When the user clicks the Submit button, the data is stored as a transaction data record in the system, and the counter will be posted on the Trading Summary Screen as a counteroffer or counterbid. If the same user places two counters against a single posting, the original counter will be updated automatically to eliminate the possibility of an IT having two counters against the same posting. However, the user may place two or more counters that differ in terms against the same underlying posting. Users may also specify how long the counterbid/offer will remain posted, as well as whether or not it will deleted when the original posting it was made against is removed. A report of the history of a posting may also be viewed.

A user may also modify his/her own bids/offers or counterbids/counteroffers by selecting the posting from the Trading Summary Screen and hitting the Modify button at the top of the screen. This function retrieves the transaction data record of that bid or offer, and allows the user to modify any of the fields thereon. Upon submission, the modified data record is stored.

New bids and offers are stored in the system's transactions database as data records identified by an assigned data record number. The data record includes fields hidden from display that identify the trader, group, or other user status, data and time of the posting, and any linkages to other group transactions. When the user acts to submit a counter or modified bid or offer, the system retrieves the data record of the selected bid or offer, and compares the trader and group ID information to that of the user requesting the counter or modification. The user will be precluded from countering the bids/offers of traders from the same group, and from modifying the bids/offers of other traders. For a legitimate action, the system sets up a new data entry form and populates its fields with data from the underlying record. The user can then add or change any of the data in the fields. Upon submitting the form for posting, the system will assign a new data record number to the counter or modified bid/offer, insert a link to the underlying data record, and store the new data record in the transaction database. The system will then post the new transaction automatically and show the new entry on the Trading Summary displays of authorized online users. For a counter bid/offer, the system will highlight the new entry on the display of the trader who submitted the original bid/offer as a counter, and send a message alerting the user. For a modified bid/offer, the system will remove the trader's original bid/offer and show the new posting as a modified bid/offer. The techniques for implementing these functions in the system database and in displays to online users are well know to those skilled in this field, and are not described in further detail herein.

A user may at any time review the details of a bid or offer by selecting the bid or offer from the Trading Summary Screen and hitting the Details button at the top of the screen. This will bring up a Bid Detail/Offer Detail screen displaying the fields of the corresponding data record. The user may then decide to make a counter or to modify the bid or offer (if it is their own), as described above.

A user may accept a bid or offer by selecting the bid or offer from the Trading Summary Screen and hitting the Accept button at the top of the screen. When a user accepts a bid or offer, they accept all the terms of that bid/offer. After successfully accepting a bid, the selected bid or offer will be highlighted and flash on all users' screens for 60 seconds. It will then be removed from all users' screens and a message will appear in the textbox at the upper right corner of the Trading Summary Screen of the two parties that the deal has closed.

The system has an automatch engine which constantly compares all postings. If two postings are a match (under the matching rules of the system), the system will automatically close a deal with no further input from either user. A match of all primary terms on any two postings is necessary for a match. Administrative terms to be included in the resulting contract do not stop the automatch engine from closing a deal but they are still binding on both parties. When a deal has been closed, the system automatically sends confirmation messages to both parties, and generates a final contract by incorporating the primary and administrative terms into a contract form. Both counterparts can view the contract prior to printing from the selection tab on the Home Page.

A user may hold or release his/her own bid or offer by selecting the bid or offer from the Trading Summary Screen and hitting the Hold/Release button at the top of the screen. When a user holds a bid/offer, it will be grayed out on the system and nobody else will be able to accept it until the owner of the bid/offer releases it. A user releases a bid/offer by hitting the Hold/Release button again.

The Trading Summary Screen offers the following options to the user to alter the display of bid and offer postings. A user may filter a list to narrow it down by clicking on the down arrow under each column heading casuing a drop down box to appear. The user then selects one or more of the desired items to filter from the drop down lists. For example, if a user would only like to see Bids originating from Brazil, they would select Brazil under the Origins drop down list. As a result, the only Bids/Offers shown on the list will be those that have sugar origins of Brazil. In addition to filtering, the user is able to re-sort the postings by clicking on the heading they wish to sort by. For example, clicking on the Origin column title will sort the list in ascending order by origin. Clicking it a second time will sort the list in descending order by origin. At any point in time, the user may click on the button labeled “Return to Market View” to return to a summary screen view with all postings. The user can also quickly find the closest match for a bid or offer using the Find Best Bids or Find Best Offers buttons. For example, as illustrated in FIG. 10, the Find Best Bids button on the lower right corner of the “Offers” half of the screen allows the user to display all closest bids to a selected offer on the left “Bids” half of the screen. Similarly, the Find Best Offers button in the lower left corner of the “Bids” half of the Trading Summary Screen results in display of all closest offers to the selected bid on the right “Offers” half of the screen.

The system also generates reports which an authorized user may view of current and past activity on the system. This includes individual positions as well as corporate positions. In addition, authorized users can see reports indicating closed deals as well as market activity without companies specified. The users can also see the Posting History report.

Whenever a deal is made, the system will automatically generate an invoice for the parties involved in the deal. The system prints out invoices for users charging them for use of the system. These invoices may be sent out weekly on or after the last day available for each shipment. A system administrator may change the invoice's amount and shipment date prior to mailing.

In the described system, the ability of a user to retrieve a transaction data record and review the detailed terms of the bid or offer and to make a counter or modify the terms of their own bid/offer provides the core function of allowing parties to move progressively toward a match. Access of a user to bids or offers of interest is controlled by the user navigation scheme of the system, so that the display of details of a bid or offer never requires identification of the submitter. The counterpart rules preclude a user's viewing and trading with parties the user has indicated they would not deal, so bids and offers from unsuitable parties are not included in the Trading Summary Screen. The settings and ID issuances of the CT Administrator preclude a user's viewing and trading with other members of their own group. The initials of a group member only appear on the displays to other group members, and not to persons who are not members of that group. The initials of the user for their own bids and offers appear only on the display to that user. Thus, the user interface logic allows all parties to a potential match to remain anonymous in the online trading system until a deal is closed, while allowing them to fine-tune their “negotiation” through the counter or modify bid/offer functions to bring their bid or offer closer to acceptance by the other party or a match.

Although not described in detail herein, the online trading system and its core features may be supplemented with functional enhancements or implemented in alternative ways. For example, instead of simply notifying a user when a close match exists separated by one primary term, the system could be modified to provide different stages of notification when a bid or offer is close to their bid or offer. For example, the system can issue messages for “Close Match By 3”, “Close Match By 2”, and “Close Match By 1” when bids or offers are separated by three, two, and one unmatched primary terms, respectively. The system can also alert the user when a Close Match has been countered or modified to reduce the separation in unmatched primary terms. Also, the sorting and filtering and Find Best Bids/Offers functions can be modified to allow the user to indicate their ranking of primary terms for a bid or offer in order of importance, so as to result in a display of “Close Matches” ranked in order of the importance of primary terms. For example, if “Quantity” is the most important term to a specific trade, the display of Close Matches to the trader would be ordered with those Close Matches that match the Quantity term at the top, so that the trader can focus on adjusting the lesser terms of those bids and offers that have met the Quantity criteria.

The system can also be modified to provide a wide range of enhanced trading management functions deemed desirable for the convenience or trading efficiency of users. A Boolean search function can be provided to allow the user to narrow a list of bids or offers of interest by more than one parameters. The system can provide pop-up lists of Close Matches, posting history summary, and/or closed transactions summary to facilitate the trader's viewing of information for understanding of the background or context of a particular item. If there are a number of Close Matches, detailed displays of their primary terms can be tiled or cascaded to allow the user to compare them all in one view. Similarly, a comparison view of multiple counters made by a trader and counters to those counters can help the trader to understand how a counterparty is responding to counters with different offered terms. The addition of such enhanced functions should take into account the desirability of maintaining ease of use and simplicty of the system.

It is to be understood that many other modifications and variations may be devised given the above description of the principles of the invention. It is intended that all such modifications and variations be considered as within the spirit and scope of this invention, as defined in the following claims.

### Appendix A

Elements of the New Bid/New Offer/Counterbid/Counteroffer/Details screens:

| Name of | |
|---|---|
| Corporate Trader | Name of trader using system |
| Transaction Number | These are unique system assigned transaction |
| | ID numbers. |
| Contract Number | The number of the contract. These are unique |
| | system assigned contract ID numbers. |
| Contract Date | The date of the contract shown when a deal has |
| | closed. |
| Name of Counterpart | |
| Remain Posted After | *Only in Counter forms. |
| the Original Posting | Specifies if the counterbid/counteroffer will |
| is Gone? | remain posted after the original posting it was |
| (YES/NO) | posted against is gone (when the original deal |
| | has not been matched). |
| Posting Duration | *Only in New Bid/New Offer/Counter forms |
| (User selects from # | Specifies the amount of time that the bid/offer |
| hours or Until Canceled) | will remain posted. |
| Group # | *Only in New Bid/New Offer/Counter forms |
| | Places the posting in the group selected by the |
| | user. |
| Commodity Information | |
| Type of Sugar | Specifies the type of sugar being traded. |
| (Whites/Raws) | |
| Origin | Specifies the origin of the sugar. |
| (User selects from a pre- | |
| populated list of | |
| countries) | |
| Quantity | Specifies the amount of sugar being Waded. |
| (User enters a number | |
| for tons of sugar) | |
| Tolerance | Specifies the tolerance level for the quantity of |
| (User selects from a list | sugar being shipped. The user does not select a |
| between 0.0%, 2.5%, | tolerance for a min/max shipment (leave the |
| 5% or 10.0%) | default 0% setting) |
| Price | Specifies the price of sugar. Price is |
| (User selects from a list | determined by market, month, pts or dollars, |
| of components making | and contract number. |
| up the price) | |
| Fixed Price | Alternately the user may indicate the price by |
| (User enters an amount) | entering the fixed price per metric ton. |
| Quality: | |
| | selection process. To select all the ports from a |
| | country or region, select the port option with |
| | the * after it. Example, Brazil.* selects all |
| | Brazilian ports. |
| Shipment Date | Specifies the time frame in which the sugar can |
| (User selects a range of | be shipped. A beginning and end date must be |
| dates from drop down | selected. Date range must have some time in |
| lists) | the future. |
| Packing | Specifies whether the sugar will be bagged or |
| (Bags/Bulk) | whether it will be transferred in bulk. |
| Bag Type/Containers | This option is available when ‘Bags’ is selected |
| (User selects from None, | for Packing. Specifies the type of bags to be |
| Polyjutes, Polypropylene | used and whether or not they will be in |
| or Other from a drop | containers. |
| down list and selects | |
| Containers or No | |
| Containers) | |

The bottom of the forms allows the user to specify the shipping terms on which to ship the sugar.

| | |
|---|---|
| Loading Terms | Specifies how many tons of sugar can be |
| (User enters loading | loaded per day per hatch per exclusions. |
| terms in loading term | |
| formats) | |
| Unloading Terms | Specifies how many tons of sugar can be |
| (User enters unloading | unloaded per day per hatch per exclusions. |
| terms in loading term | |
| formats) | |
| As per Charter party | This allows the users to let the charter party set |
| | Demurrage and Dispatch rates. |
| Demurrage Rate | Specifies penalty in price for slow loading.. |
| (User enters rate with | Expressed as dollars per day. |
| a maximum of six digits) | |
| Dispatch Rate | Specifies bonus in price for fast loading. |
| (User enters rate with a | Expressed as dollars per day. |
| maximum of six digits) | *Rate is usually half the demurrage rate and is |
| | automatically filled in by the system. User has |
| | the option of modifying this rate. |
| Payment | Specifies the payment terms for the delivery of |
| (User selects from a list: | the sugar. |
| CAD through a Bank, | |
| CAD, L/C or Other) | |
| Ship Requirement | Specifies special ship requirements |
| (User selects from a list: | |
| Bulk Carrier, Twin | |
| Decker, Panamax, Cape | |
| Size or None) | |
| Arbitration | Specifies the company that will settle |
| (User selects from a list) | arbitration disputes. |
| Standard Contract Terms | Show the standard contact terms as entered by |
| (User enters terms of | the CT. |
| contract into a textbox) | |
| Special Terms | Allows the user to define any special terms for |
| (User enters misc, special | the contract not captured by the system. |
| terms into a textbox) | |
| MIN Pol | Minimum Polarization quality measure. |
| (User enters a number | |
| greater than or equal | |
| to 96) | |
| MAX Pol | Maximum Polarization quality measure. |
| (User enters a number | |
| greater than or equal | |
| to 96) | |
| Icumsa | Quality measure. |
| (User enters a number) | |
| Humidity | Quality measure. |
| (User enters a number | |
| in percent format i.e. | |
| Must be less than 1.00) | |
| Ashes | Quality measure. |
| (User enters a number | |
| in percent format i.e. | |
| Must be less than 1.00) | |
| Shipment Information | |
| Term | Specifies the shipment terms. |
| (User selects from FOB | |
| Stowed, FOB Stowed | |
| Range, FAS, CIF, | |
| or CFR) | |
| Liner Out/Free Out | This option can be selected if the terms of |
| (User selects from a list) | shipment are CIF or CFR. If terms other than |
| | these are selected, NONE is defaulted. |
| Notice of Readiness | Notice of Readiness for shipment |
| (User enters a number) | |
| Shipment Origin | User may specify acceptable and unacceptable |
| (User selects the | ports for the sugar by first selecting the desired |
| Country/Region and | country or region and then selecting a port from |
| Ports from drop down | the list. The user then clicks on the ‘Add |
| lists) | Acceptable Ports’ or ‘Add Not Acceptable |
| | Ports’ button. User may also remove ports |
| | from the list by selecting the port and clicking |
| | the ‘Remove’ button. |
| | *To select one or more ports, repeat the |
| | selection process. To select all the ports from a |
| | country or region, select the port option with |
| | the * after it. Example, Brazil.* selects all |
| | Brazilian ports. |
| Shipment Destination | *This option is only available if the user |
| (User selects the | chooses User may specify acceptable and |
| Country/Region and | unacceptable ports for the sugar by first |
| Ports from drop down | selecting the desired country or region and then |
| lists) | selecting a port from the list. The user then |
| | clicks on the ‘Add Acceptable Ports’ or ‘Add |
| | Not Acceptable Ports’ button. User may also |
| | remove ports from the list by selecting the port |
| | and clicking the ‘Remove’ button. |
| | *To select one or more ports, repeat the |

### Appendix B

Computer hardware and software needed to run NodLeT application

Computer/Processor:

486DX/66 MHz or higher. (a Pentium processor is preferred.)

Operating System:

Windows 95, Windows 98, or Windows NT 4.0. If you are running a version of Windows NT, you must be running Windows NT Service Pack 3 or higher. If you are running the Hebrew or Arabic version of Windows 98, you cannot install the English language version of Internet Explorer 5.

Memory: (128MB is desired for good performance)

For Windows 95/98 and Windows NT:

32MB of RAM minimum.

Hard drive space:

Minimal install (Browser-only)

Required for install: 45MB

Required to run: 27 MB after restart.

Typical install:

Required for install: 70 MB

Required to run: 55 MB after restart.

Full Install:

Required for install: 111MB

Required to run: 80 MB after restart.

Mouse & Modem

Internet connection

CD-ROM drive (if installation is done from a CD-ROM)

Some components may require additional systems resources not outlined above

Browser: Microsoft Explorer higher than 4.0; preferably 5.0

Internet access speed (56KB)

1. An online trading system comprising:
(a) a Bid/Offer input interface for allowing a user to enter terms in a predetermined set of fields for a bid or offer and to submit the bid or offer for posting in the system anonymously without identification of the submitter;
(b) a Trading Summary interface operable by users for displaying an anonymous postings of bids and offers submitted to the system, and for identifying a match of a bid and a counterpart offer with respect to the terms in the predetermined set of fields of each counterpart;
(c) a Bid/Offer database for storing and retrieving data records of bids and offers submitted to the system; and
(d) a Counter Bid/Offer interface operable by a user to select a pending bid or offer displayed on a display of the Trading Summary interface, to retrieve the corresponding data record from the Bid/Offer database and display the terms existing in the predetermined set of fields without identification of the submitter, and then to counter or modify one or more terms and submit the countered or modified bid or offer as a new posting in the system without identification of the submitter,
whereby users of the system can remain anonymous while engaging in countering or modifying an original bid or offer as a new posting in the system in order to move progressively toward a match of terms in the predetermined set of fields.

2. An online trading system according to claim 1, wherein the Bid/Offer input interface includes a predetermined set of fields typical of commodities contracts.

3. An online trading system according to claim 1, further having an Administration interface for registering users authorized to access the system over a network connection, and for checking users logging on to the system over a network connection for such authorization before providing access to the system.

4. An online trading system according to claim 3, wherein the Administration interface includes a trading rules function for setting preferences of a user as to counterparties that the user is willing to enage in trading activities with, wherein said Administration interface loads the preferences set for a user when the user logs on to the system in order to display only bids and offers on the Trading Summary interface submitted by parties that meet the user's preferences.

5. An online trading system according to claim 1, further having an Administration interface for registering a group of users who are members of the same company and are authorized to access the system over a network connection, and for checking users logging on to the system over a network connection for such authorization before providing access to the system.

6. An online trading system according to claim 5, wherein the Administration interface includes a trading rules function for setting preferences for all members of a company as to counterparties the company is willing to enage in trading activities with, wherein said Administration interface loads the preferences set for a user as a member of the company when the user logs on to the system in order to display only bids and offers on the Trading Summary interface submitted by parties that meet the company's preferences.

7. An online trading system according to claim 1, wherein the Trading Summary interface includes a filter for filtering out for display only those bids and offers which meet a given filter criterion.

8. An online trading system according to claim 7, wherein the Trading Summary interface displays a limited set of parameters for each bid and offer in columns corresponding to the parameters, and the filter is operated to filter bids and offers in accordance with a column parameter selected by the user.

10. An online trading system according to claim 7, wherein the Trading Summary interface displays bids in one part of a display view to the user and offers in another part of the display view, and the filter is operated to filter the closest matching bids to a selected offer, and vice versa.

11. An online trading system according to claim 1, wherein the Counter Bid/Offer interface is operable by the user to retrieve the data record of a selected bid or offer submitted by a counterparty and to generate a counteroffer or counterbid by incorporating the terms of the selected bid or offer and any change or modification to the terms entered by the user.

12. An online trading system according to claim 1, wherein the Counter Bid/Offer interface is operable by the user to retrieve the data record of a selected bid or offer submitted by the user and to generate a modified offer or bid by incorporating the terms of the selected bid or offer and any change or modification to the terms entered by the user.

13. An online trading system according to claim 6, wherein the Trading Summary interface provides a display to the user in which bids or offers submitted by other users of the same company are identified and accepting or matching such bids or offers is precluded.

14. An online trading system according to claim 1, wherein a match of a bid and counterpart offer is determined by the Trading Summary interface when all terms in the predetermined set of fields match.

15. An online trading system according to claim 14, wherein a close match of a bid and counterpart offer is determined by the Trading Summary interface when the terms in the predetermined set of fields are separated by a predetermined number of unmatched terms.

16. An online trading system according to claim 15, wherein a close match is determined by the predetermined number of unmatched terms being one.

17. An online trading system according to claim 1, wherein the Trading Summary interface generates a final contract between the parties when a match is determined which incorporates the matched terms of the predetermined set of fields.

18. An online trading system according to claim 17, wherein the Bid/Offer input interface includes an additional field for entry of administrative terms for inclusion in the final contract between the parties but which are not taken into account by the Trading summary interface in determining a match.

19. A method of conducting online trading comprising:
(a) allowing a user to access an online trading system and enter terms in a predetermined set of fields for a bid or offer and to submit the bid or offer for posting in the system anonymously without identification of the submitter;
(b) displaying an anonymous postings of bids and offers submitted to the system, and identifying a match of a bid and a counterpart offer with respect to the terms in the predetermined set of fields in each counterpart;
(c) storing data records of the bids and offers submitted to the system;
(c) retrieving the data record of a bid or offer selected by a user and providing a display of the terms existing in the predetermined set of fields for the bid or offer without identification of the submitter, and allowing the user to change or modify one or more terms and submit the countered or modified bid or offer as a new posting in the system without identification of the submitter,
whereby users of the system can remain anonymous while engaging in countering or modifying an original bid or offer as a new posting in the system in order to move progressively toward a match of terms in the predetermined set of fields.

20. A method of conducting online trading according to claim 19, further comprising: precluding a user from selecting a bid or offer for countering which was submitted by a party which has been predeterminedly identified as a party the user is precluded from trading with.
